(19) United States
(12) Patent Application Publication
(10) Pub. No.: US 2026/0268928 A1
(43) Pub. Date: Sep. 10, 2026

(54) MAGNETIC RECORDING DEVICE

(71) Applicants: Kabushiki Kaisha Toshiba, Kawasaki-shi (JP); Toshiba Electronic Devices & Storage Corporation, Kawasaki-shi (JP)

(72) Inventors: Yuji NAKAGAWA, Kawasaki Kanagawa (JP); Tomoyuki MAEDA, Kawasaki Kanagawa (JP); Masayuki TAKAGISHI, Kunitachi Tokyo (JP); Naoyuki NARITA, Funabashi Chiba (JP); Junki NUMATA, Kawasaki Kanagawa (JP)

(21) Appl. No.: 19/532,589

(22) Filed: Feb. 6, 2026

(30) Foreign Application Priority Data
Mar. 5, 2025 (JP) 2025-034785

(51) Int. Cl. G11B 5/31; G11B 5/02

(52) U.S. Cl. CPC G11B 5/3146; G11B 5/02

(57) ABSTRACT

According to one embodiment, a magnetic recording device includes a magnetic head and a controller. The magnetic head includes a first magnetic pole, a second magnetic pole, a third magnetic pole, a fourth magnetic pole, and a coil. A second direction from the third magnetic pole to the fourth magnetic pole crosses a first direction from the first magnetic pole to the second magnetic pole. The controller includes a coil current circuit configured to supply a coil current to the coil to generate a magnetic field from the first magnetic pole according to the coil current, and a magnetic pole current circuit configured to supply a magnetic pole current between the third magnetic pole and the fourth magnetic pole. A polarity of the magnetic pole current changes according to a polarity of the coil current.

### CROSS-REFERENCE TO RELATED APPLICATIONS

This application is based upon and claims the benefit of priority from Japanese Patent Application No. 2025-034785, filed on Mar. 5, 2025; the entire contents of which are incorporated herein by reference.

### FIELD

Embodiments described herein relate generally to a magnetic recording device.

### BACKGROUND

Information is recorded on a magnetic recording medium such as a hard disk drive (HDD) by using a magnetic head. In magnetic recording devices, it is desirable to improve the recording density.

### BRIEF DESCRIPTION OF THE DRAWINGS

FIG. 1 is a schematic plan view illustrating a magnetic recording device according to a first embodiment;

FIG. 2 is a schematic cross-sectional view illustrating the magnetic recording device according to the first embodiment;

FIG. 3 is a schematic diagram illustrating the operation of the magnetic recording device according to the first embodiment;

FIG. 4 is a schematic diagram illustrating the operation of the magnetic recording device according to the first embodiment;

FIG. 5 is a schematic diagram illustrating the operation of the magnetic recording device according to the first embodiment;

FIG. 6 is a schematic diagram illustrating the operation of the magnetic recording device according to the first embodiment;

FIG. 7 is a schematic diagram illustrating the operation of the magnetic recording device according to the first embodiment;

FIG. 8 is a schematic diagram illustrating the operation of the magnetic recording device according to the first embodiment;

FIG. 9 is a schematic diagram illustrating the operation of the magnetic recording device according to the first embodiment;

FIG. 10 is a schematic diagram illustrating the operation of the magnetic recording device according to the first embodiment;

FIG. 11 is a schematic diagram illustrating the operation of the magnetic recording device according to the first embodiment;

FIG. 12 is a schematic diagram illustrating the operation of the magnetic recording device according to the first embodiment;

FIG. 13 is a schematic plan view illustrating a magnetic recording device according to a second embodiment;

FIG. 14 is a schematic diagram illustrating the operation of the magnetic recording device according to the second embodiment;

FIG. 15 is a schematic diagram illustrating the operation of the magnetic recording device according to the second embodiment;

FIG. 16 is a schematic diagram illustrating the operation of the magnetic recording device according to the second embodiment;

FIG. 17 is a schematic diagram illustrating the operation of the magnetic recording device according to the second embodiment;

FIGS. 18A to 18E are schematic cross-sectional views illustrating magnetic heads according to the second embodiment;

FIG. 19 is a schematic plan view illustrating a magnetic recording device according to the second embodiment;

FIGS. 20A to 20C are schematic plan views illustrating the magnetic recording device according to an embodiment;

FIGS. 21A to 21D are schematic plan views illustrating the magnetic recording device according to the embodiment;

FIG. 22 is a schematic diagram illustrating a magnetic recording device according to the embodiment;

FIGS. 23A to 23C are schematic diagrams illustrating magnetic recording devices according to the embodiment;

FIG. 24 is a schematic perspective view illustrating the magnetic recording device according to an embodiment;

FIG. 25 is a schematic perspective view illustrating a part of the magnetic recording device according to an embodiment;

FIG. 26 is a schematic perspective view illustrating the magnetic recording device according to the embodiment; and

FIGS. 27A and 27B are schematic perspective views illustrating a part of a magnetic recording device according to an embodiment.

### DETAILED DESCRIPTION

According to one embodiment, a magnetic recording device includes a magnetic head and a controller. The magnetic head includes a first magnetic pole, a second magnetic pole, a third magnetic pole, a fourth magnetic pole, and a coil. A second direction from the third magnetic pole to the fourth magnetic pole crosses a first direction from the first magnetic pole to the second magnetic pole. The controller includes a coil current circuit configured to supply a coil current to the coil to generate a magnetic field from the first magnetic pole according to the coil current, and a magnetic pole current circuit configured to supply a magnetic pole current between the third magnetic pole and the fourth magnetic pole. A polarity of the magnetic pole current changes according to a polarity of the coil current.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

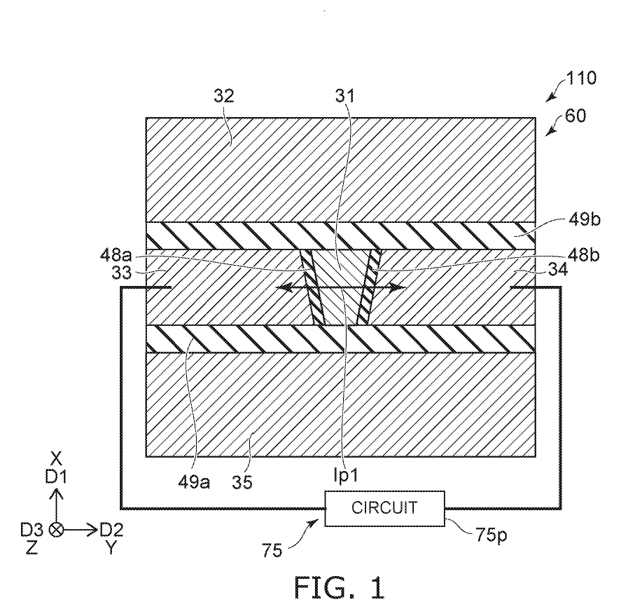

FIG. 1 is a schematic plan view illustrating a magnetic recording device according to a first embodiment.

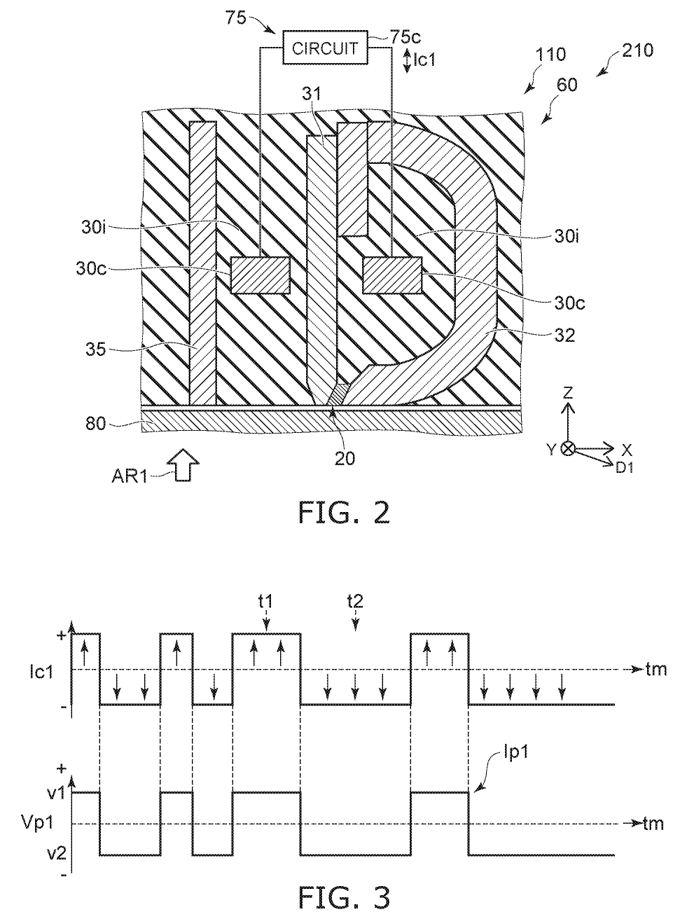

FIG. 2 is a schematic cross-sectional view illustrating the magnetic recording device according to the first embodiment.

FIG. 1 is a plan view seen along the arrow AR1 in FIG. 2.

As shown in FIGS. 1 and 2, a magnetic recording device 210 according to the embodiment includes a magnetic head 110 and a controller 75. The magnetic recording device 210 may include a magnetic recording medium 80. As shown in FIG. 2, the magnetic head 110 includes a coil 30c.

As shown in FIG. 1, the magnetic head 110 includes a first magnetic pole 31, a second magnetic pole 32, a third magnetic pole 33, and a fourth magnetic pole 34. A second direction D2 from the third magnetic pole 33 to the fourth magnetic pole 34 crosses a first direction D1 from the first magnetic pole 31 to the second magnetic pole 32.

A third direction D3 from the magnetic recording medium 80 to the magnetic head 110 crosses a plane including the first direction D1 and the second direction D2. The third direction D3 is the height direction. The third direction D3 is defined as a Z-axis direction. One direction perpendicular to the Z-axis direction is defined as an X-axis direction. A direction perpendicular to the Z-axis direction and the X-axis direction is defined as a Y-axis direction. The second direction D2 may be along the Y-axis direction, for example.

The first direction D1 may correspond to the down-track direction, for example. The second direction D2 may correspond to the cross-track direction, for example. The third direction D3 may correspond to the height direction.

As shown in FIG. 2, the controller 75 includes a coil current circuit 75c. The coil current circuit 75c is configured to supply a coil current Ic1 to the coil 30c to generate a magnetic field corresponding to the coil current Ic1 from at least one of the first magnetic pole 31, the second magnetic pole 32, the third magnetic pole 33, and the fourth magnetic pole 34. The coil current Ic1 corresponds to the recording information recorded on the magnetic recording medium 80. The magnetic field corresponding to the coil current Ic1 corresponds to the recording magnetic field. The magnetic recording medium 80 may be, for example, a perpendicular magnetic recording medium. The polarity (direction) of the coil current Ic1 changes according to the recording information. For example, the coil current circuit 75c is configured to change the polarity of the coil current Ic1 according to the recording information.

As shown in FIG. 1, the controller 75 includes a magnetic pole current circuit 75p. The magnetic pole current circuit 75p is configured to supply a magnetic pole current Ip1 between the third magnetic pole 33 and the fourth magnetic pole 34. The magnetic pole current Ip1 passes through the first magnetic pole 31 via the third magnetic pole 33 and the fourth magnetic pole 34. In the embodiment, the polarity (direction) of the magnetic pole current Ip1 changes. For example, the polarity of the magnetic pole current Ip1 changes depending on the polarity of the coil current Ic1. This allows a high recording capability to be obtained. For example, a high recording density can be obtained.

For example, a magnetic field is generated by the pole current Ip1. At least a part of the magnetic field includes a component along the third direction D3. At least a part of the magnetic field includes a component along the third direction D3, which has the same orientation as the component of the recording magnetic field (magnetic field corresponding to the coil current Ic1) along the third direction D3.

For example, at least a part of the magnetic field generated by the pole current Ip1 includes a component along the X-axis direction. The magnetic field generated by the pole current Ip1 changes the angle of the magnetic field applied to the magnetic recording medium 80 with respect to the third direction D3.

For example, the magnetic pole current Ip1 can assist the recording magnetic field (magnetic field corresponding to the coil current Ic1). By assisting the recording magnetic field, high recording capability can be obtained. For example, high recording density can be obtained. According to the embodiment, a magnetic recording device capable of improving recording density can be provided.

For example, the magnetic pole current Ip1 improves the responsiveness of the magnetization of at least one of the first magnetic pole 31, the third magnetic pole 33, and the fourth magnetic pole 34 to changes in the polarity of the coil current Ic1. For example, the magnetic pole current Ip1 makes the change of the magnetization of at least one of the first magnetic pole 31, the third magnetic pole 33, and the fourth magnetic pole 34 in response to changes in the polarity of the coil current Ic1 quicker. For example, the magnetic pole current Ip1 makes the change of the magnetization of at least one of the first magnetic pole 31, the third magnetic pole 33, and the fourth magnetic pole 34 smoother in response to changes in the polarity of the coil current Ic1. For example, the magnetic field generated by the magnetic pole current Ip1 acts on at least one of the first magnetic pole 31, the third magnetic pole 33, and the fourth magnetic pole 34. The magnetic pole current Ip1 improves the responsiveness of the recording magnetic field to changes in the polarity of the coil current Ic1. For example, the magnetic pole current Ip1 makes the change in the magnetization of at least one of the first magnetic pole 31, the third magnetic pole 33, and the fourth magnetic pole 34 quicker in response to the change in polarity of the coil current Ic1. For example, the magnetic pole current Ip1 makes the change in the magnetization of at least one of the first magnetic pole 31, the third magnetic pole 33, and the fourth magnetic pole 34 smoother in response to the change in polarity of the coil current Ic1. For example, a high recording density can be obtained. According to the embodiment, a magnetic recording device capable of improving the recording density can be provided.

The above effect of the magnetic pole current Ip1 is asymmetric with respect to the sign of the magnetic pole current Ip1. For example, the above effect of the magnetic pole current Ip1 is antisymmetric with respect to the sign of the magnetic pole current Ip1. As described above, in the embodiment, the polarity (direction) of the magnetic pole current Ip1 changes. For example, the polarity of the magnetic pole current Ip1 changes according to the polarity of the coil current Ic1. This results in high recording capability. For example, high recording density can be obtained.

Examples of the coil current Ic1 and the magnetic pole current Ip1 will be described later.

As shown in FIG. 1, in this example, the magnetic head 110 includes a first non-magnetic conductive layer 48a and a second non-magnetic conductive layer 48b. The first non-magnetic conductive layer 48a is provided between the third magnetic pole 33 and the first magnetic pole 31. The second non-magnetic conductive layer 48b is provided between the first magnetic pole 31 and the fourth magnetic pole 34. The magnetic pole current Ip1 flows through these non-magnetic conductive layers. The first non-magnetic conductive layer 48a and the second non-magnetic conductive layer 48b include, for example, Ru, Ta, Ir, Rh, Pd, Pt, and W, and include, for example, Cu, Au, Cr, V, Al, and Ag.

In the embodiment, the first magnetic pole 31 may be, for example, a main magnetic pole. The second magnetic pole 32 may be, for example, a trailing shield. The third magnetic pole 33 and the fourth magnetic pole 34 may be, for example, side shields.

In this example, the magnetic head 110 includes a fifth magnetic pole 35. The first magnetic pole 31 is between the fifth magnetic pole 35 and the second magnetic pole 32. The fifth magnetic pole 35 may be, for example, a leading shield.

In this example, the magnetic head 110 includes a first non-magnetic member 49a and a second non-magnetic member 49b. A part of the first non-magnetic member 49a is provided between a part of the fifth magnetic pole 35 and the third magnetic pole 33. Another part of the first non-magnetic member 49a is provided between a part of the fifth magnetic pole 35 and the fourth magnetic pole 34.

A part of the second non-magnetic member 49b is provided between the third magnetic pole 33 and a part of the second magnetic pole 32. Another part of the second non-magnetic member 49b is provided between the fourth magnetic pole 34 and another part of the second magnetic pole 32. The first non-magnetic member 49a and the second non-magnetic member 49b may be, for example, an insulating layer.

The first magnetic pole 31, the second magnetic pole 32, the third magnetic pole 33, the fourth magnetic pole 34 and the fifth magnetic pole 35 may include, for example, at least one selected from the group consisting of Fe, Co and Ni.

As shown in FIG. 2, an insulating portion 30i is provided around these magnetic poles and the coil 30c. As shown in FIG. 2, the first direction D1 may be inclined with respect to the X-axis direction. An element portion 20, which will be described later, is depicted in FIG. 2. As shown in FIG. 1, the element portion 20 may be omitted.

Below, examples of the coil current Ic1 and the magnetic pole current Ip1 will be described. The magnetic pole current Ip1 flows according to the potential between the third magnetic pole 33 and the fourth magnetic pole 34. Hereinafter, a potential of the fourth magnetic pole 34 based on a potential of the third magnetic pole 33 will be referred to as a fourth magnetic pole potential Vp1.

FIGS. 3 to 12 are schematic diagrams illustrating the operation of the magnetic recording device according to the first embodiment.

These figures illustrate the waveforms of the coil current Ic1, the magnetic pole current Ip1, and the fourth magnetic pole potential Vp1. The horizontal axis of these figures represents time tm.

As shown in FIG. 3, the polarity of the magnetic pole current Ip1 changes depending on the polarity of the coil current Ic1. For example, at a first time t1, the coil current Ic1 has a first recording polarity (positive in this example). At a second time t2, the coil current Ic1 has a second recording polarity (negative in this example) that is different from the first recording polarity.

At the first time t1, the fourth magnetic pole potential Vp1 of the fourth magnetic pole 34 relative to the third magnetic pole 33 is a first potential v1. At the second time t2, the fourth magnetic pole potential Vp1 is a second potential v2 different from the first potential v1.

In the example of FIG. 3, the first recording polarity at the first time t1 is positive, and the second recording polarity at the second time t2 is negative. The first potential v1 is higher than the second potential v2. The first potential v1 is positive, and the second potential v2 is negative.

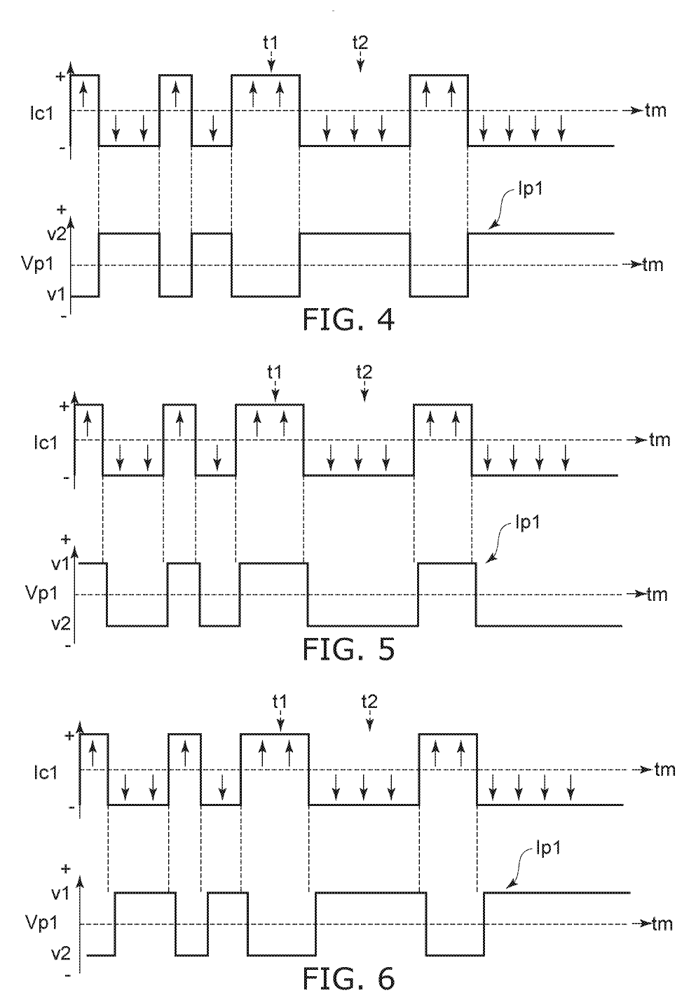

In the example of FIG. 4, the first recording polarity at the first time t1 is positive, and the second recording polarity at the second time t2 is negative. The first potential v1 is lower than the second potential v2. The first potential v1 is negative, and the second potential v2 is positive.

As in the examples shown in FIGS. 5 and 6, the phase of the change in the coil current Ic1 may be shifted from the phase of the change in the magnetic pole current Ip1. The phase of the change in the coil current Ic1 may be shifted from the phase of the change in the fourth magnetic pole potential Vp1. In these examples, the magnetic pole current Ip1 and the fourth magnetic pole potential Vp1 change with a delay based on the change in the coil current Ic1.

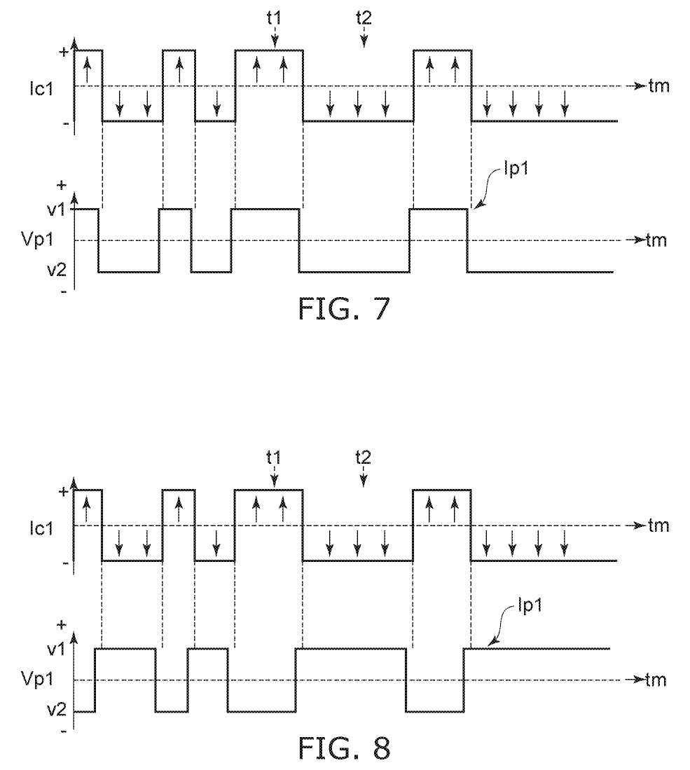

As shown in the examples of FIGS. 7 and 8, the phase of the change in the coil current Ic1 may be shifted from the phase of the change in the magnetic pole current Ip1. The phase of the change in the coil current Ic1 may be shifted from the phase of the change in the fourth magnetic pole potential Vp1. In these examples, the coil current Ic1 changes with a delay based on the changes in the magnetic pole current Ip1 and the fourth magnetic pole potential Vp1.

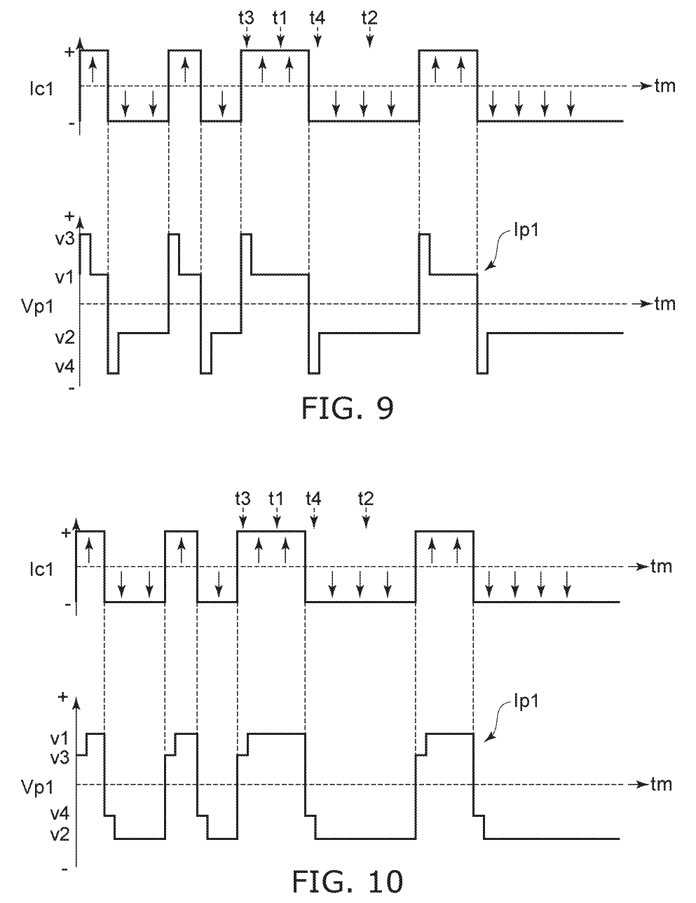

As shown in the example of FIG. 9, the fourth magnetic pole potential Vp1 may change in three or more values. In this example, at the first time t1, the fourth magnetic pole potential Vp1 is the first potential v1. At the second time t2, the fourth magnetic pole potential Vp1 is the second potential v2 different from the first potential v1. At a third time t3, the coil current Ic1 is the first recording polarity (positive in this example). At a fourth time t4, the coil current Ic1 is the second recording polarity (negative in this example). At the third time t3, the fourth magnetic pole potential Vp1 is at a third potential v3. At the fourth time t4, the fourth magnetic pole potential Vp1 is at a fourth potential v4.

In this example, the first potential v1 is between the fourth potential v4 and the third potential v3. The second potential v2 is between the fourth potential v4 and the first potential v1.

In the example shown in FIG. 10, the third potential v3 is between the second potential v2 and the first potential v1. The fourth potential v4 is between the second potential v2 and the third potential v3.

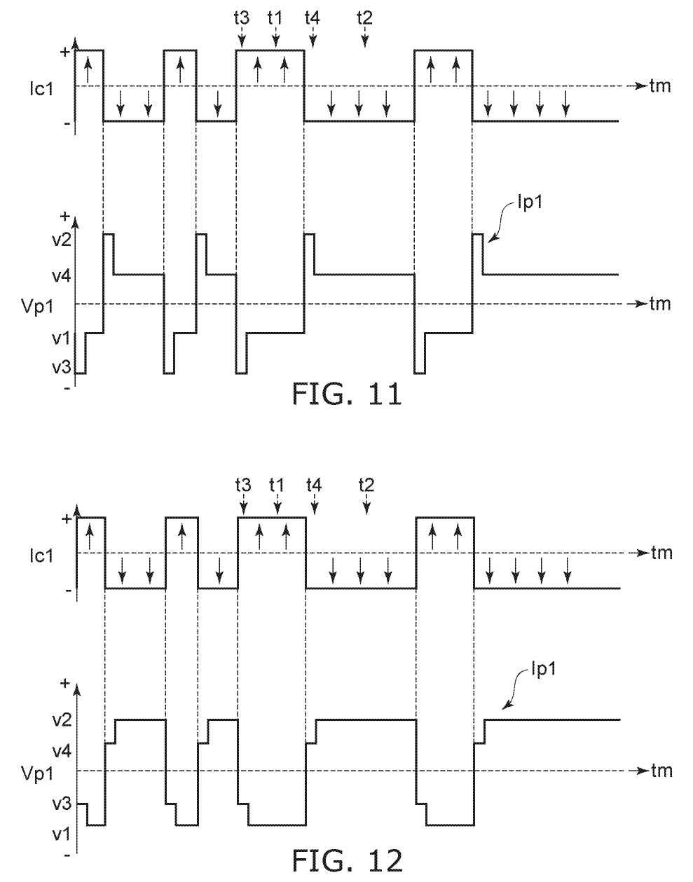

As shown in FIG. 11, the polarities of the magnetic pole current Ip1 and the fourth magnetic pole potential Vp1 in the example described with reference to FIG. 9 may be reversed. As shown in FIG. 12, the polarities of the magnetic pole current Ip1 and the fourth magnetic pole potential Vp1 in the example described with reference to FIG. 10 may be reversed.

In the examples of FIGS. 3 to 12, the potential of the first magnetic pole 31 is between the first potential v1 and the second potential v2. In the embodiment, the time average of the magnetic pole current Ip1 may be substantially zero.

### Second Embodiment

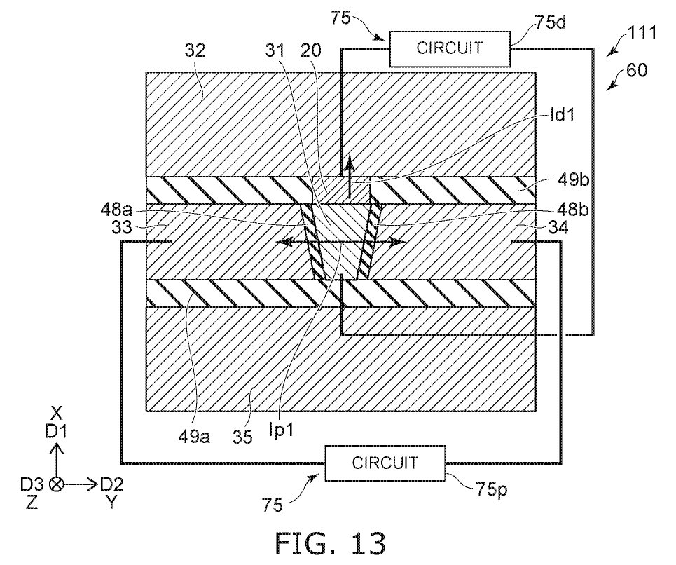

FIG. 13 is a schematic plan view illustrating a magnetic recording device according to a second embodiment.

As shown in FIG. 13, a magnetic head 111 according to the embodiment further includes an element portion 20. The controller 75 includes an element current circuit 75d. Except for these, the configuration of the magnetic head 111 may be the same as the configuration of the magnetic head 110.

The element portion 20 is between the first magnetic pole 31 and the second magnetic pole 32. The element current circuit 75d included in the controller 75 is configured to supply an element current Id1 to the element portion 20.

For example, the element current Id1 may pass through at least one of a first path, a second path, or the third path. The first path includes the first magnetic pole 31, the element portion 20, and the second magnetic pole 32. The second path includes the third magnetic pole 33, the element portion 20, and the second magnetic pole 32. The third path includes the fourth magnetic pole 34, the element portion 20, and the second magnetic pole 32.

The element current Id1 may include, for example, a DC component. In one example, the element current Id1 may have a direction from the first magnetic pole 31 to the second magnetic pole 32. In another example, the element current Id1 may have a direction from the second magnetic pole 32 to the first magnetic pole 31. The element current Id1 may, for example, further improve the recording characteristics. For example, a magnetic field is generated by the element current Id1. The element current Id1 may assist the recording magnetic field (magnetic field corresponding to the coil current Ic1). For example, the element current Id1 improves the responsiveness of the recording magnetic field generated by the first magnetic pole 31 and the second magnetic pole 32 to changes in the coil current Ic1. For example, the effect of the element current Id1 is added to the effect of the magnetic pole current Ip1.

In the embodiment, the element current circuit 75d may be configured to change the element current Id1 in response to a change in polarity of the magnetic pole current Ip1. For example, the element current Id1 may change in response to a change in polarity of the magnetic pole current Ip1. The element current circuit 75d may be configured to change the element current Id1 in response to a change in polarity of the coil current Ic1. By changing the element current Id1, higher recording characteristics can be obtained. For example, the responsiveness of the recording magnetic field is further improved.

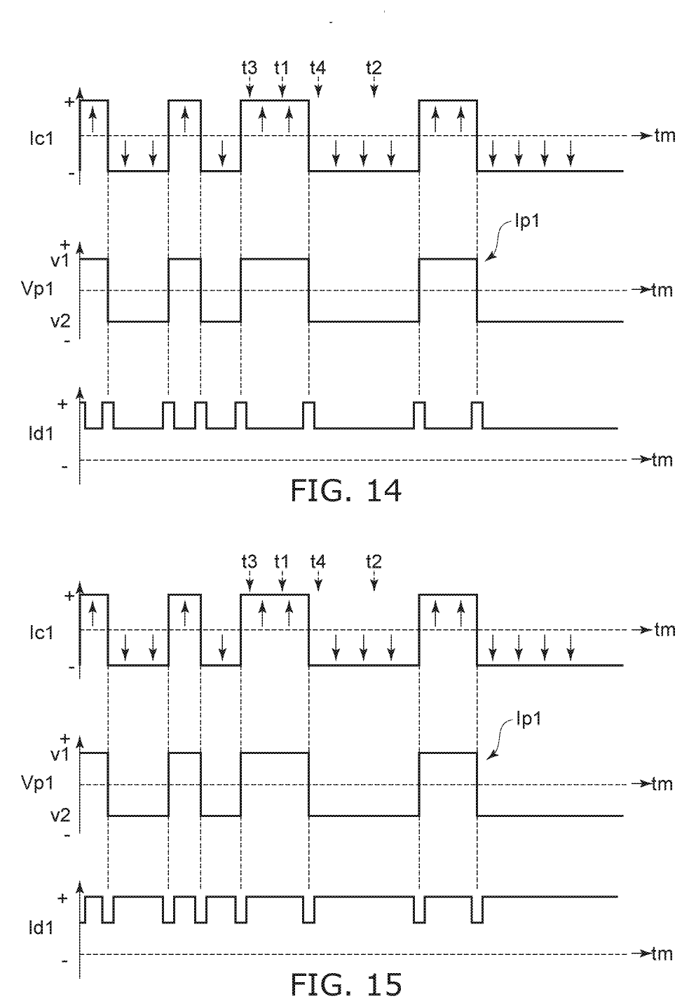

FIGS. 14 to 17 are schematic diagrams illustrating the operation of the magnetic recording device according to the second embodiment.

These figures illustrate the waveforms of the coil current Ic1, the magnetic pole current Ip1, the fourth magnetic pole potential Vp1, and the element current Id1. The horizontal axis of these figures represents time tm.

As shown in FIGS. 14 to 17, the magnitude of the element current Id1 changes in response to changes in the polarity of the coil current Ic1. The magnitude of the element current Id1 changes in response to changes in the polarity of the magnetic pole current Ip1 and the fourth magnetic pole potential Vp1.

As shown in the example of FIG. 14, the magnitude of the element current Id1 may increase when the coil current Ic1 changes. The magnitude of the element current Id1 may increase when the magnetic pole current Ip1 changes. For example, the improved responsiveness of the recording magnetic field is maintained even in periods when the absolute value of the magnetic pole current Ip1 is small.

As shown in the example of FIG. 15, the magnitude of the element current Id1 may decrease when the coil current Ic1 changes. The magnitude of the element current Id1 may decrease when the magnetic pole current Ip1 changes. For example, in a period when the absolute value of the magnetic pole current Ip1 is small, the assist effect of the recording magnetic field by the element current Id1 also decreases. In a period when the absolute value of the magnetic pole current Ip1 increases, the assist effect of the recording magnetic field by the element current Id1 also increases. The change in the recording magnetic field influenced by the assist effect becomes clearer. The responsiveness of the recording magnetic field influenced by the assist effect improves. For example, the change in the recording magnetic field influenced by the assist effect becomes quicker in response to a change in the polarity of the coil current Ic1. The amount of decrease in the element current Id1 when the coil current Ic1 changes may be greater than the value of the element current Id1 when the coil current Ic1 does not change.

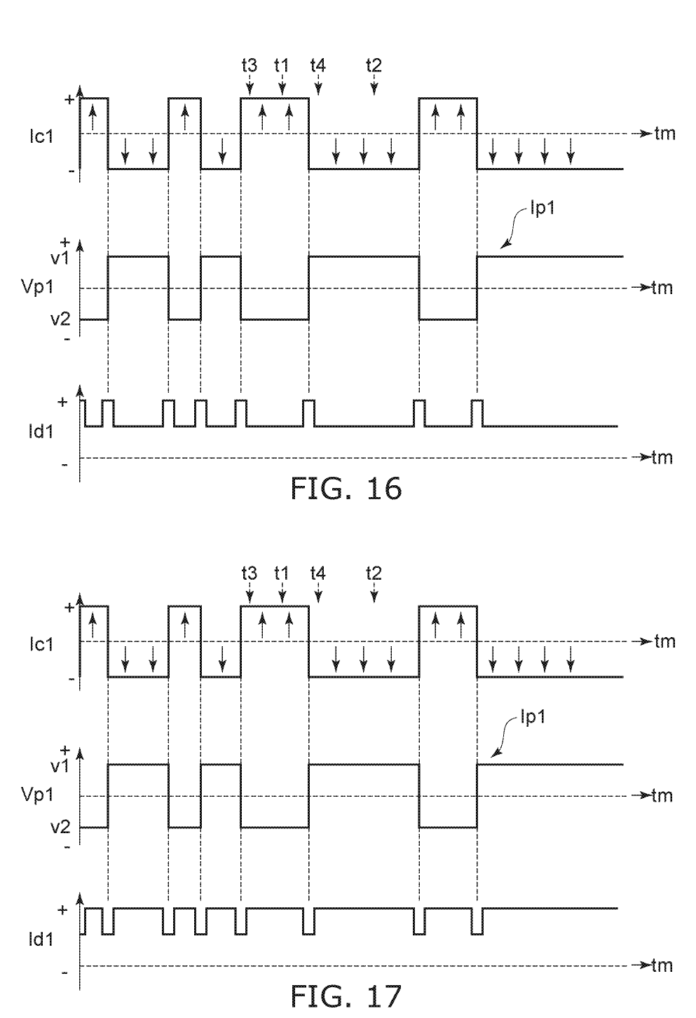

As shown in FIGS. 16 and 17, the polarity of the magnetic pole current Ip1 in FIGS. 14 and 15 may be reversed.

In the examples of FIGS. 14 to 17, the examples related to FIGS. 3 to 12 may be applied. As shown in FIGS. 14 to 17, the element current Id1 may include a DC component. For example, the absolute value of the time average of the element current Id1 is greater than the absolute value of the time average of the magnetic pole current Ip1. As already explained, the time average of the magnetic pole current Ip1 may be substantially zero.

Below, several examples related to the element portion 20 will be explained.

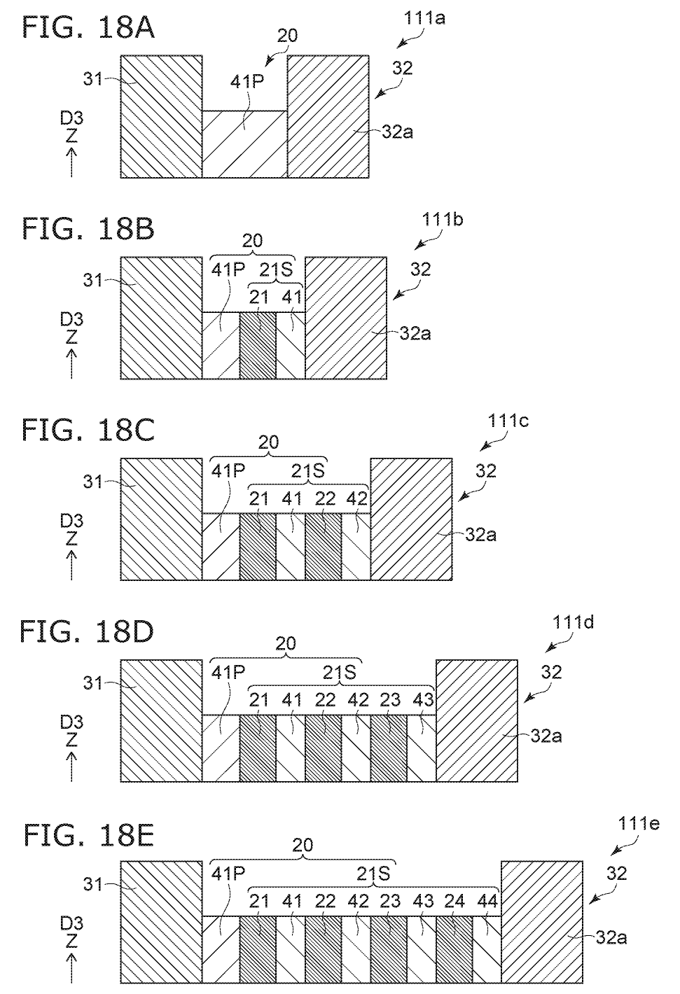

FIGS. 18A to 18E are schematic cross-sectional views illustrating the magnetic head according to the second embodiment.

In these examples, the first magnetic pole 31 and the second magnetic pole 32 can be interchanged with each other. As shown in FIG. 18A, in a magnetic head 111a according to the embodiment, the element portion 20 includes a first magnetic pole side non-magnetic layer 41P. The first magnetic pole side non-magnetic layer 41P is in contact with the first magnetic pole 31. The first magnetic pole side non-magnetic layer 41P includes at least one element selected from the group consisting of Ru, Ta, Ir, Rh, Pd, Pt, and W (first element group).

As shown in FIG. 18B, in a magnetic head 111b according to the embodiment, the element portion 20 includes the first magnetic pole side non-magnetic layer 41P and a first stacked body 21S. The first magnetic pole side non-magnetic layer 41P is between the first magnetic pole 31 and the first stacked body 21S. In this example, the first stacked body 21S includes a first magnetic layer 21 and a first non-magnetic layer 41. The first magnetic layer 21 is between the first magnetic pole side non-magnetic layer 41P and the first non-magnetic layer 41. In this example, the first non-magnetic layer 41 includes at least one element selected from the group consisting of Cu, Au, Cr, V, Al, and Ag (second element group).

As shown in FIG. 18C, in a magnetic head 111c according to the embodiment, the first stacked body 21S further includes a second magnetic layer 22 and a second non-magnetic layer 42. The second magnetic layer 22 is between the first magnetic layer 21 and the second non-magnetic layer 42. The second non-magnetic layer 42 may include at least one element selected from the above-mentioned first element group, or at least one element selected from the above-mentioned second element group.

As shown in FIG. 18D, in a magnetic head 111d according to the embodiment, the first stacked body 21S further includes a third magnetic layer 23 and a third non-magnetic layer 43. The third magnetic layer 23 is between the second magnetic layer 22 and the third non-magnetic layer 43. The third non-magnetic layer 43 may include at least one element selected from the first element group described above, or at least one element selected from the second element group described above.

As shown in FIG. 18E, in a magnetic head 111e according to the embodiment, the first stacked body 21S further includes a fourth magnetic layer 24 and a fourth non-magnetic layer 44. The fourth magnetic layer 24 is between the third magnetic layer 23 and the fourth non-magnetic layer 44. The fourth non-magnetic layer 44 may include at least one element selected from the first element group described above, or at least one element selected from the second element group described above.

At least one of the first magnetic layer 21, the second magnetic layer 22, the third magnetic layer 23, or the fourth magnetic layer 24 includes at least one selected from the group consisting of Fe, Co, and Ni. At least one of the first magnetic layer 21, the second magnetic layer 22, the third magnetic layer 23, or the fourth magnetic layer 24 may further include at least one selected from the group consisting of Cr, V, Mn, Ti, and Sc in addition to the above.

In these configurations, for example, the magnetization of at least one of the first magnetic layer 21, the second magnetic layer 22, the third magnetic layer 23, or the fourth magnetic layer 24 is easily changed by the element current Id1. For example, the magnetization of at least one of the first magnetic layer 21, the second magnetic layer 22, the third magnetic layer 23, or the fourth magnetic layer 24 is easily reversed by the element current Id1. For example, the magnetization of at least one of the first magnetic layer 21, the second magnetic layer 22, the third magnetic layer 23, or the fourth magnetic layer 24 is likely to oscillate by the element current Id1. The magnetization reversal or the assist effect by the oscillation is likely to be obtained. Higher recording characteristics are obtained.

The magnetic field generated by the pole current Ip1 also acts on the element portion 20, for example. By changing the element current Id1 in accordance with changes in the pole current Ip1, the magnetization of at least one of the first magnetic layer 21, the second magnetic layer 22, the third magnetic layer 23, or the fourth magnetic layer 24 can be stably changed even if the magnetic field generated by the pole current Ip1 changes. For example, a higher recording density can be obtained.

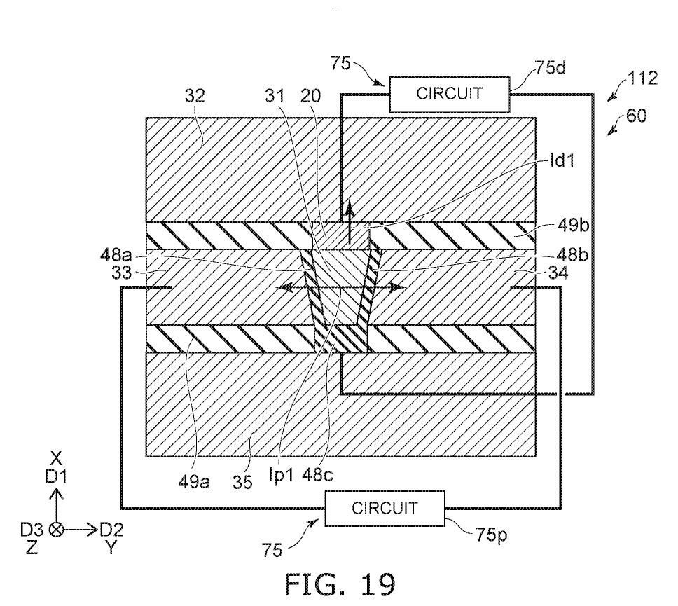

FIG. 19 is a schematic plan view illustrating the magnetic recording device according to the second embodiment.

As shown in FIG. 19, a magnetic head 112 according to the embodiment includes a third non-magnetic conductive layer 48c. Except for this, the configuration of the magnetic head 112 may be the same as the configuration of the magnetic head 111.

The first magnetic pole 31 is between the fifth magnetic pole 35 and the second magnetic pole 32. The third non-magnetic conductive layer 48c is between the fifth magnetic pole 35 and the first magnetic pole 31.

The element current Id1 may be supplied to the first magnetic pole 31 via the fifth magnetic pole 35 and the second magnetic pole 32. The third non-magnetic conductive layer 48c includes, for example, Ru, Ta, Ir, Rh, Pd, Pt, and W. It may also include Cu, Au, Cr, V, Al, and Ag.

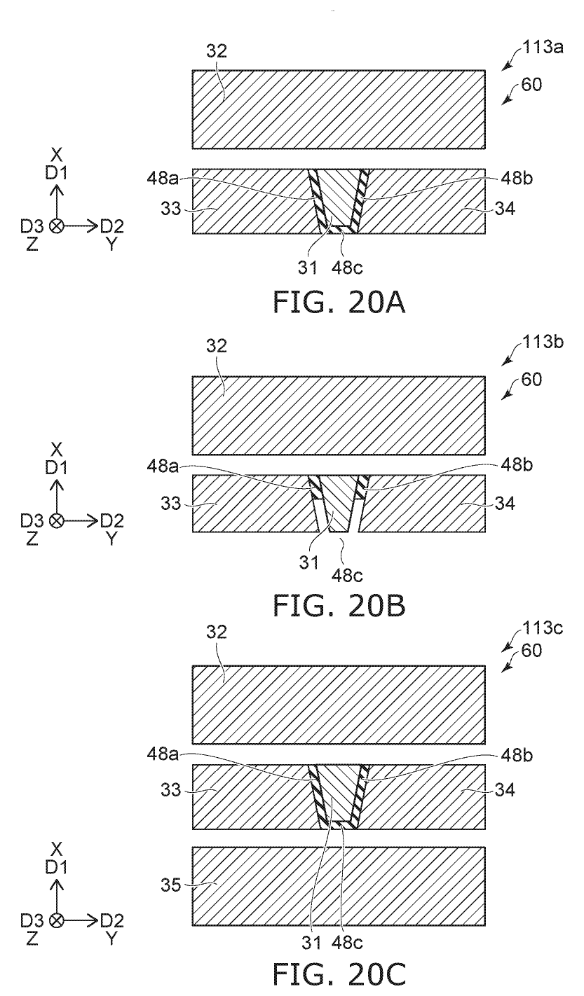

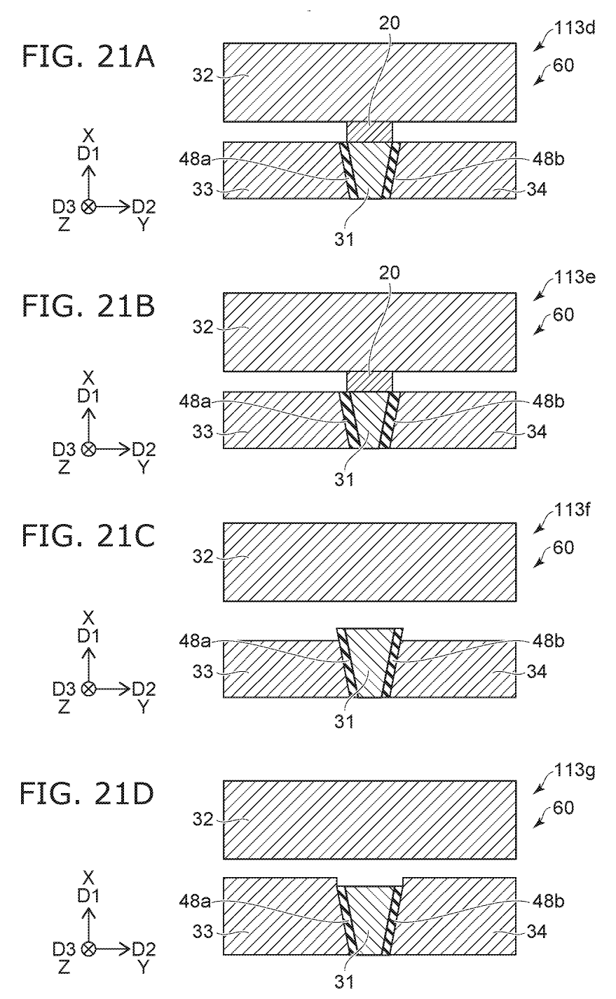

FIGS. 20A-20C and 21A-21D are schematic plan views illustrating the magnetic recording device according to an embodiment.

In these figures, the first non-magnetic member 49a and the second non-magnetic member 49b have been omitted.

As shown in FIG. 20A, in a magnetic head 113a according to the embodiment, the third non-magnetic conductive layer 48c is between a part of the third magnetic pole 33 and a part of the fourth magnetic pole 34.

As shown in FIG. 20B, in a magnetic head 113b according to the embodiment, the first non-magnetic conductive layer 48a is between a part of the third magnetic pole 33 and a part of the first magnetic pole 31. Another region between the third magnetic pole 33 and the first magnetic pole 31 may include an insulating member. The second non-magnetic conductive layer 48b is between a part of the first magnetic pole 31 and a part of the fourth magnetic pole 34. Another region between the first magnetic pole 31 and the fourth magnetic pole 34 may include an insulating member.

As shown in FIG. 20C, a magnetic head 113c according to the embodiment includes the fifth magnetic pole 35. The third non-magnetic conductive layer 48c is between a part of the third magnetic pole 33 and a part of the fourth magnetic pole 34.

As shown in FIG. 21A, in a magnetic head 113d according to the embodiment, the width of the element portion 20 along the second direction D2 is the same as the width of the first magnetic pole 31 along the second direction D2.

As shown in FIG. 21B, in a magnetic head 113e according to the embodiment, the element portion 20 overlaps the first non-magnetic conductive layer 48a and the second non-magnetic conductive layer 48b in the first direction D1.

As shown in FIG. 21C, in a magnetic head 113f according to the embodiment, a distance between the first magnetic pole 31 and the second magnetic pole 32 along the first direction D1 is shorter than a distance between the third magnetic pole 33 and the second magnetic pole 32 along the first direction D1. The distance between the first magnetic pole 31 and the second magnetic pole 32 along the first direction D1 is shorter than a distance between the fourth magnetic pole 34 and the second magnetic pole 32 along the first direction D1.

As shown in FIG. 21D, in a magnetic head 113g according to the embodiment, the distance between the first magnetic pole 31 and the second magnetic pole 32 along the first direction D1 is longer than the distance between the third magnetic pole 33 and the second magnetic pole 32 along the first direction D1. The distance between the first magnetic pole 31 and the second magnetic pole 32 along the first direction D1 is longer than the distance between the fourth magnetic pole 34 and the second magnetic pole 32 along the first direction D1.

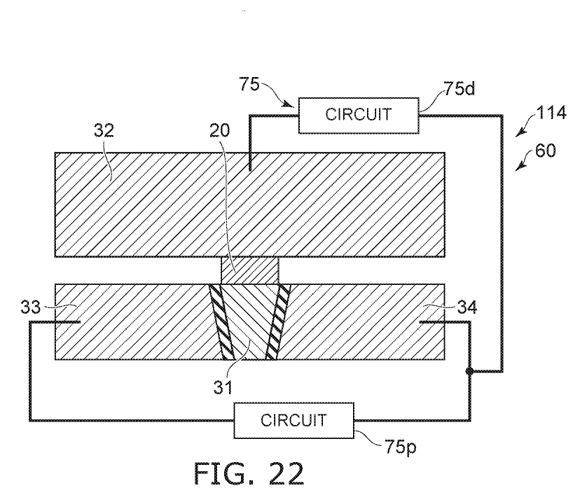

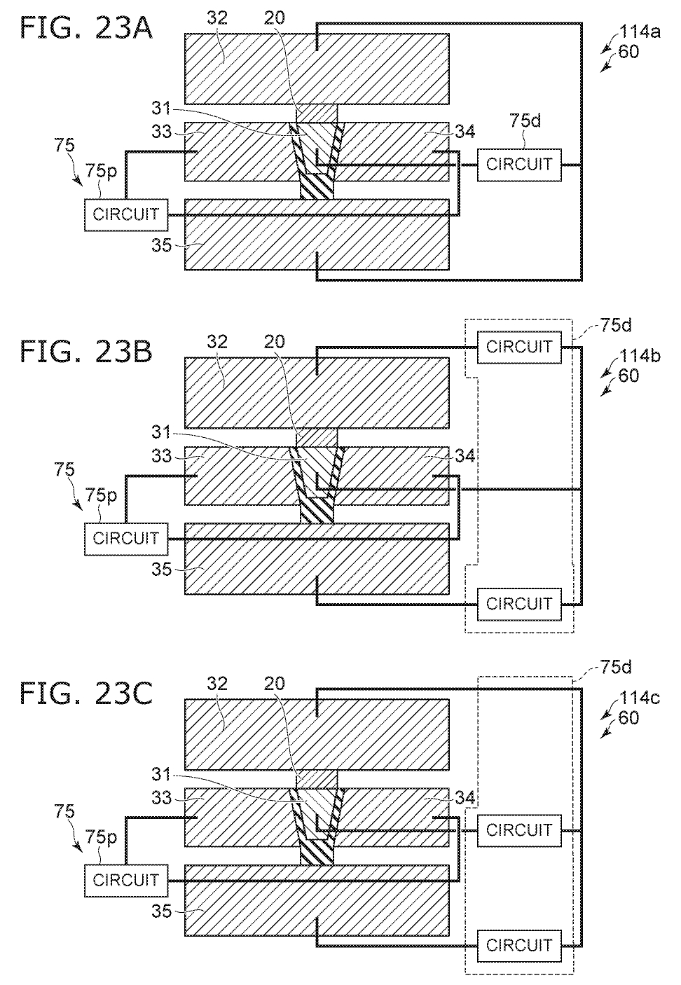

FIGS. 22 and 23A-23C are schematic diagrams illustrating the magnetic recording devices according to the embodiment.

As shown in FIG. 22, in a magnetic recording device 114 according to the embodiment, the element current circuit 75d is electrically connected to the fourth magnetic pole 34 and the second magnetic pole 32. The element current circuit 75d may also be electrically connected to the third magnetic pole 33 and the second magnetic pole 32.

As shown in FIG. 23A, in a magnetic recording device 114a according to the embodiment, one end of the element current circuit 75d is electrically connected to the fifth magnetic pole 35 and the second magnetic pole 32. The other end of the element current circuit 75d is electrically connected to the first magnetic pole 31. The other end of the element current circuit 75d may also be electrically connected to the first magnetic pole 31 via one of the third magnetic pole 33 or the fourth magnetic pole 34.

As shown in FIG. 23B, in a magnetic recording device 114b according to the embodiment, one end of a part of the element current circuit 75d is electrically connected to the fifth magnetic pole 35. The other end of the part of the element current circuit 75d is electrically connected to the first magnetic pole 31. The other end of the part of the element current circuit 75d may be connected to the first magnetic pole 31 via the fourth magnetic pole 34 (or the third magnetic pole 33). One end of another part of the element current circuit 75d is electrically connected to the second magnetic pole 32. The other end of the other part of the element current circuit 75d is electrically connected to the first magnetic pole 31. The other end of the other part of the element current circuit 75d may be connected to the first magnetic pole 31 via the fourth magnetic pole 34 (or the third magnetic pole 33).

As shown in FIG. 23C, in a magnetic recording device 114c according to the embodiment, one end of a part of the element current circuit 75d is electrically connected to the fifth magnetic pole 35. The other end of the part of the element current circuit 75d is electrically connected to the second magnetic pole 32. One end of the other part of the element current circuit 75d is electrically connected to the second magnetic pole 32. The other end of the other part of the element current circuit 75d is electrically connected to the first magnetic pole 31. The other end of the other part of the element current circuit 75d may be connected to the first magnetic pole 31 via the fourth magnetic pole 34 (or the third magnetic pole 33).

In the embodiment, various configurations may be applied to the circuit connections.

Below, examples of the magnetic head and magnetic recording medium 80 included in the magnetic recording device 210 according to the embodiment are described.

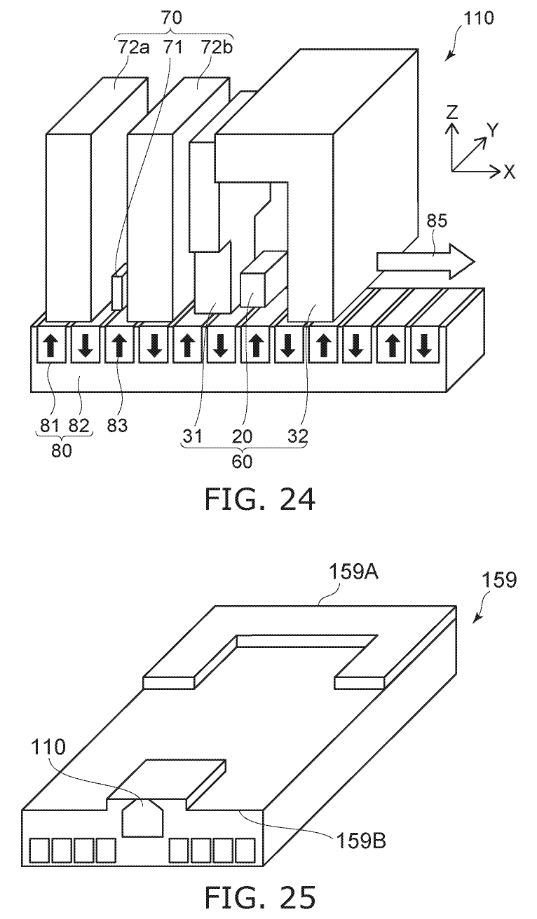

FIG. 24 is a schematic perspective view illustrating the magnetic recording device according to an embodiment.

As shown in FIG. 24, a magnetic head according to the embodiment (e.g., magnetic head 110) is used together with the magnetic recording medium 80. In this example, the magnetic head 110 includes a recording section 60 and a reproducing section 70. The recording section 60 of the magnetic head 110 records information on the magnetic recording medium 80. The reproducing section 70 reproduces the information recorded on the magnetic recording medium 80.

The magnetic recording medium 80 includes, for example, a medium substrate 82 and a magnetic recording layer 81 provided on the medium substrate 82. The magnetization 83 of the magnetic recording layer 81 is controlled by the recording section 60.

The reproducing section 70 includes, for example, a first reproducing magnetic shield 72a, a second reproducing magnetic shield 72b, and a magnetic reproducing element 71. The magnetic reproducing element 71 is provided between the first reproducing magnetic shield 72a and the second reproducing magnetic shield 72b. The magnetic reproducing element 71 can output a signal corresponding to the magnetization 83 of the magnetic recording layer 81.

As shown in FIG. 24, the magnetic recording medium 80 moves relative to the magnetic head 110 in a medium movement direction 85. The magnetic head 110 controls information corresponding to the magnetization 83 of the magnetic recording layer 81 at any position. The magnetic head 110 reproduces information corresponding to the magnetization 83 of the magnetic recording layer 81 at any position.

FIG. 25 is a schematic perspective view illustrating a part of the magnetic recording device according to an embodiment.

FIG. 25 illustrates a head slider.

The magnetic head 110 is provided on a head slider 159. The head slider 159 includes, for example, Al₂O₃/TiC. The head slider 159 moves relative to the magnetic recording medium while floating above or in contact with the magnetic recording medium.

The head slider 159 has, for example, an air inflow side 159A and an air outflow side 159B. The magnetic head 110 is disposed on the side of the air outflow side 159B of the head slider 159. As a result, the magnetic head 110 moves relative to the magnetic recording medium while floating above or in contact with the magnetic recording medium.

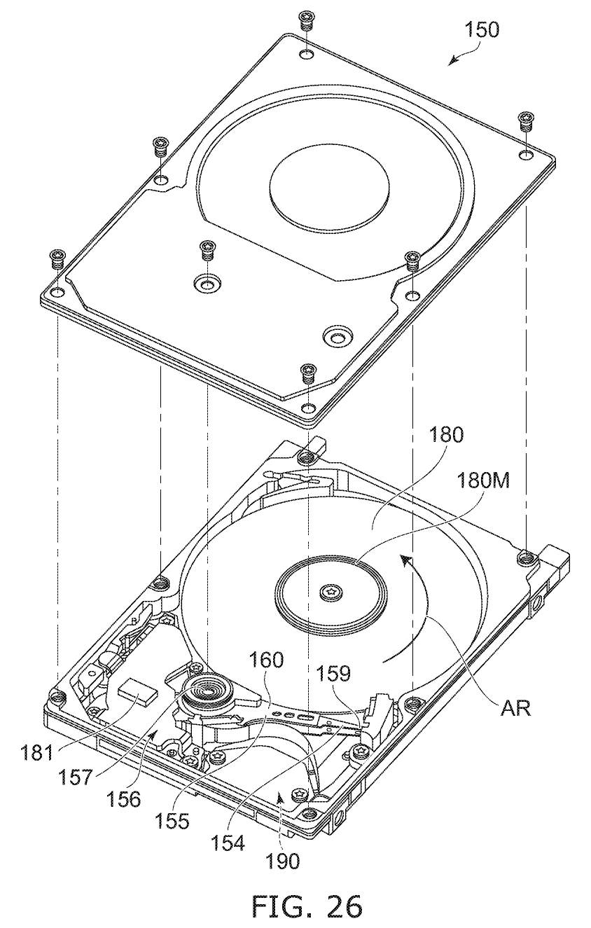

FIG. 26 is a schematic perspective view illustrating the magnetic recording device according to the embodiment.

As shown in FIG. 26, in a magnetic recording device 150 according to the embodiment, a rotary actuator is used. The recording medium disk 180 is connected to a spindle motor 180M. The recording medium disk 180 is rotated in a direction of arrow AR by the spindle motor 180M. The spindle motor 180M is responsive to control signals from the drive device controller. The magnetic recording device 150 according to the embodiment may include the multiple recording medium disks 180. The magnetic recording device 150 may include a recording medium 181. The recording medium 181 is, for example, an SSD (Solid State Drive). A non-volatile memory such as a flash memory is used for the recording medium 181, for example. For example, the magnetic recording device 150 may be a hybrid HDD (Hard Disk Drive).

The head slider 159 records and reproduces information to be recorded on the recording medium disk 180. The head slider 159 is provided at an end of a thin-film suspension 154. A magnetic head according to the embodiment is provided near the end of the head slider 159.

While the recording medium disk 180 is rotating, the pressing pressure by the suspension 154 and the floating pressure generated at the medium facing face (ABS) of the head slider 159 are balanced. The distance between the medium facing face of the head slider 159 and the surface of the recording medium disk 180 is the predetermined fly height. In the embodiment, the head slider 159 may contact the recording medium disk 180. For example, a contact sliding type may be applied.

The suspension 154 is connected to one end of an arm 155 (e.g., an actuator arm). The arm 155 includes, for example, a bobbin part or the like. The bobbin part holds a drive coil. A voice coil motor 156 is provided at the other end of the arm 155. The voice coil motor 156 is a type of linear motor. The voice coil motor 156 includes, for example, a drive coil and a magnetic circuit. The drive coil is wound on the bobbin part of the arm 155. The magnetic circuit includes permanent magnets and opposing yokes. The drive coil is provided between the permanent magnet and the opposing yoke. The suspension 154 includes one end and the other end. The magnetic head is provided at one end of the suspension 154. The arm 155 is connected to the other end of the suspension 154.

The arm 155 is held by ball bearings. Ball bearings are provided at two locations above and below a bearing part 157. The arm 155 can be rotated and slid by the voice coil motor 156. The magnetic head can move to any position on the recording medium disk 180.

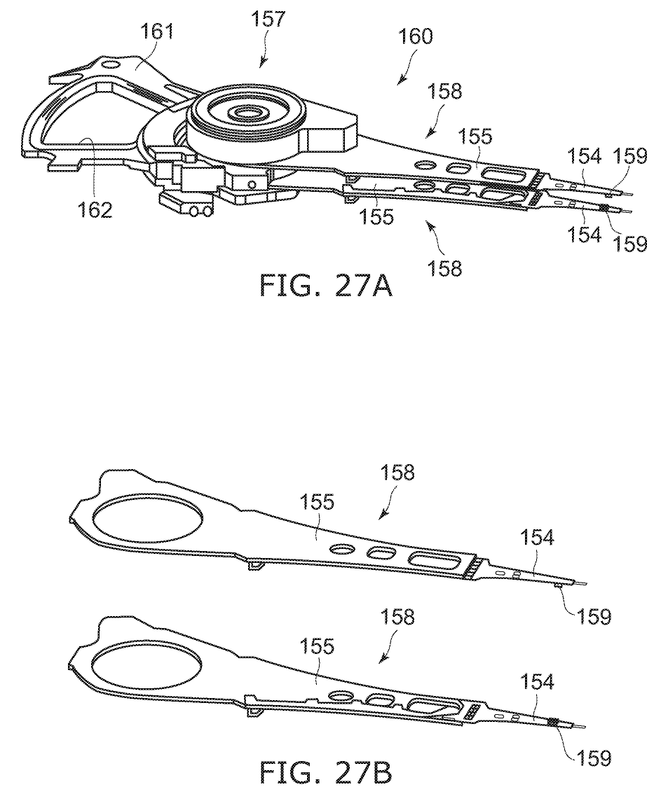

FIGS. 27A and 27B are schematic perspective views illustrating a part of a magnetic recording device according to an embodiment.

FIG. 27A illustrates the configuration of a part of the magnetic recording device, and is an enlarged perspective view of a head stack assembly 160.

FIG. 27B is a perspective view illustrating the magnetic head assembly (head gimbal assembly: HGA) 158 that is part of the head stack assembly 160.

As shown in FIG. 27A, the head stack assembly 160 includes the bearing part 157, the magnetic head assembly 158 and a support frame 161. The magnetic head assembly 158 extends from the bearing part 157. The support frame 161 extends from the bearing part 157. A direction in which the support frame 161 extends is opposite to a direction in which the magnetic head assembly 158 extends. The support frame 161 supports a coil 162 of the voice coil motor 156.

As shown in FIG. 27B, the magnetic head assembly 158 includes the arm 155 extending from the bearing part 157 and the suspension 154 extending from the arm 155.

The head slider 159 is provided at the end of the suspension 154. The head slider 159 is provided with the magnetic head according to the embodiment.

The magnetic head assembly 158 (head gimbal assembly) according to the embodiment includes the magnetic head according to the embodiment, the head slider 159 provided with the magnetic head, the suspension 154 and the arm 155. The head slider 159 is provided at one end of the suspension 154. The arm 155 is connected to the other end of the suspension 154.

The suspension 154 may include, for example, a wiring (not shown) for recording and reproducing signals. The suspension 154 may include, for example, a heater wiring (not shown) for adjusting the fly height. The suspension 154 may include a wiring (not shown) for, for example, an oscillator element or the like. These wires may be electrically connected to multiple electrodes provided on the magnetic head.

A signal processor 190 is provided in the magnetic recording device 150. The signal processor 190 uses a magnetic head to record and reproduce signals on a magnetic recording medium. Input/output lines of the signal processor 190 are connected to, for example, electrode pads of the magnetic head assembly 158 and electrically connected to the magnetic head.

The magnetic recording device 150 according to the embodiment includes the magnetic recording medium, the magnetic head according to the embodiment, a movable part, a position controller, and a signal processor. The movable part separates the magnetic recording medium from the magnetic head or makes them relatively movable while they are in contact with each other. The position controller aligns the magnetic head with a predetermined recording position on the magnetic recording medium. The signal processor records and reproduces signals on the magnetic recording medium using the magnetic head.

For example, the recording medium disk 180 is used as the above magnetic recording medium. The movable part includes, for example, the head slider 159. The position controller described above includes, for example, the magnetic head assembly 158.

The embodiments may include the following Technical proposals:

### Technical proposal 1

A magnetic recording device, comprising:

a magnetic head; and

a controller,

the magnetic head including:

a first magnetic pole,

a second magnetic pole,

a third magnetic pole,

a fourth magnetic pole, a second direction from the third magnetic pole to the fourth magnetic pole crossing a first direction from the first magnetic pole to the second magnetic pole, and

a coil,

the controller including:

a coil current circuit configured to supply a coil current to the coil to generate a magnetic field from the first magnetic pole according to the coil current, and

a magnetic pole current circuit configured to supply a magnetic pole current between the third magnetic pole and the fourth magnetic pole,

a polarity of the magnetic pole current changes according to a polarity of the coil current.

### Technical proposal 2

The magnetic recording device according to Technical proposal 1, wherein

at a first time, the coil current is a first recording polarity,

at a second time, the coil current is a second recording polarity different from the first recording polarity,

at the first time, a fourth magnetic pole potential of the fourth magnetic pole based on the third magnetic pole is a first potential,

at the second time, the fourth magnetic pole potential is a second potential different from the first potential.

### Technical proposal 3

The magnetic recording device according to Technical proposal 2, wherein

a potential of the first magnetic pole is between the first potential and the second potential.

### Technical proposal 4

The magnetic recording device according to any one of Technical proposals 1-3, wherein

a time average of the magnetic pole current is substantially zero.

### Technical proposal 5

The magnetic recording device according to any one of Technical proposals 1-3, wherein

the magnetic head further includes an element portion,

the element portion is between the first magnetic pole and the second magnetic pole, and

the controller further includes an element current circuit configured to supply an element current to the element portion.

### Technical proposal 6

The magnetic recording device according to Technical proposal 5, wherein

the element current passes through at least one of a first path, a second path, or a third path,

the first path includes the first magnetic pole, the element portion, and the second magnetic pole,

the second path includes the third magnetic pole, the element portion, and the second magnetic pole, and

the third path includes the fourth magnetic pole, the element portion, and the second magnetic pole.

### Technical proposal 7

The magnetic recording device according to Technical proposal 5 or 6, wherein

the element current circuit is configured to change the element current in response to a change in the polarity of the magnetic pole current.

### Technical proposal 8

The magnetic recording device according to Technical proposal 5 or 6, wherein

the element current circuit is configured to change the element current in response to a change in the polarity of the coil current.

### Technical proposal 9

The magnetic recording device according to any one of Technical proposals 5-8, wherein

a time average of the element current is greater than a time average of the magnetic pole current.

### Technical proposal 10

A magnetic recording device, comprising:

a magnetic head; and

a controller,

the magnetic head including:

a first magnetic pole,

a second magnetic pole,

a third magnetic pole,

a fourth magnetic pole, a second direction from the third magnetic pole to the fourth magnetic pole crossing a first direction from the first magnetic pole to the second magnetic pole, and

an element portion between the first magnetic pole and the second magnetic pole,

the controller including:

a magnetic pole current circuit configured to supply a magnetic pole current between the third magnetic pole and the fourth magnetic pole, and

an element current circuit configured to supply an element current to the element portion, and

the element current circuit being configured to change the element current in response to a change in a polarity of the magnetic pole current.

### Technical proposal 11

The magnetic recording device according to Technical proposal 10, wherein

the element current passes through at least one of a first path, a second path, or a third path,

the first path includes the first magnetic pole, the element portion, and the second magnetic pole,

the second path includes the third magnetic pole, the element portion, and the second magnetic pole, and

the third path includes the fourth magnetic pole, the element portion, and the second magnetic pole.

### Technical proposal 12

The magnetic recording device according to Technical proposal 10 or 11, wherein

a time average of the element current is greater than a time average of the magnetic pole current.

### Technical proposal 13

The magnetic recording device according to any one of Technical proposals 5-12, wherein

the element portion includes a first-pole-side non-magnetic layer in contact with the first pole, and

the first-pole-side non-magnetic layer includes at least one selected from the group consisting of Ru, Ta, Ir, Rh, Pd, Pt, and W.

### Technical proposal 14

The magnetic recording device according to Technical proposal 13, wherein

the element portion further includes a first stacked body,

the first pole side non-magnetic layer is between the first pole and the first stacked body,

the first stacked body includes a first magnetic layer and a first non-magnetic layer, and

the first magnetic layer is between the first pole side non-magnetic layer and the first non-magnetic layer.

### Technical proposal 15

The magnetic recording device according to any one of Technical proposals 1-14, wherein

the magnetic head further includes

a first non-magnetic conductive layer between the third magnetic pole and the first magnetic pole, and

a second non-magnetic conductive layer between the first magnetic pole and the fourth magnetic pole.

### Technical proposal 16

The magnetic recording device according to any one of Technical proposals 1-15, wherein

the magnetic head further includes a fifth magnetic pole and a third non-magnetic conductive layer,

the first magnetic pole is between the fifth magnetic pole and the second magnetic pole, and

the third non-magnetic conductive layer is between the fifth magnetic pole and the first magnetic pole.

### Technical proposal 17

The magnetic recording device according to any one of Technical proposals 1-9, wherein

the coil current circuit is configured to change the polarity of the coil current according to a recording information.

According to the embodiment, a magnetic recording device that can improve recording density can be provided.

In the specification of the application, "perpendicular" and "parallel" refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in magnetic recording devices such as magnetic poles, element portions, magnetic layers, non-magnetic layers, magnetic recording mediums and controller, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic recording devices practicable by an appropriate design modification by one skilled in the art based on the magnetic recording devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic recording device, comprising:
a magnetic head; and
a controller,
the magnetic head including:
a first magnetic pole,
a second magnetic pole,
a third magnetic pole,
a fourth magnetic pole, a second direction from the third magnetic pole to the fourth magnetic pole crossing a first direction from the first magnetic pole to the second magnetic pole, and
a coil,
the controller including:
a coil current circuit configured to supply a coil current to the coil to generate a magnetic field from the first magnetic pole according to the coil current, and
a magnetic pole current circuit configured to supply a magnetic pole current between the third magnetic pole and the fourth magnetic pole,
a polarity of the magnetic pole current changes according to a polarity of the coil current.

2. The magnetic recording device according to claim 1, wherein
at a first time, the coil current is a first recording polarity,
at a second time, the coil current is a second recording polarity different from the first recording polarity,
at the first time, a fourth magnetic pole potential of the fourth magnetic pole based on the third magnetic pole is a first potential,
at the second time, the fourth magnetic pole potential is a second potential different from the first potential.

3. The magnetic recording device according to claim 2, wherein
a potential of the first magnetic pole is between the first potential and the second potential.

4. The magnetic recording device according to claim 1, wherein
a time average of the magnetic pole current is substantially zero.

5. The magnetic recording device according to claim 1, wherein
the magnetic head further includes an element portion,
the element portion is between the first magnetic pole and the second magnetic pole, and
the controller further includes an element current circuit configured to supply an element current to the element portion.

6. The magnetic recording device according to claim 5, wherein
the element current passes through at least one of a first path, a second path, or a third path,
the first path includes the first magnetic pole, the element portion, and the second magnetic pole,
the second path includes the third magnetic pole, the element portion, and the second magnetic pole, and
the third path includes the fourth magnetic pole, the element portion, and the second magnetic pole.

7. The magnetic recording device according to claim 5, wherein
the element current circuit is configured to change the element current in response to a change in the polarity of the magnetic pole current.

8. The magnetic recording device according to claim 5, wherein
the element current circuit is configured to change the element current in response to a change in the polarity of the coil current.

9. The magnetic recording device according to claim 5, wherein
a time average of the element current is greater than a time average of the magnetic pole current.

10. A magnetic recording device, comprising:
a magnetic head; and
a controller,
the magnetic head including:
a first magnetic pole,
a second magnetic pole,
a third magnetic pole,
a fourth magnetic pole, a second direction from the third magnetic pole to the fourth magnetic pole crossing a first direction from the first magnetic pole to the second magnetic pole, and
an element portion between the first magnetic pole and the second magnetic pole,
the controller including:
a magnetic pole current circuit configured to supply a magnetic pole current between the third magnetic pole and the fourth magnetic pole, and
an element current circuit configured to supply an element current to the element portion, and
the element current circuit being configured to change the element current in response to a change in a polarity of the magnetic pole current.

11. The magnetic recording device according to claim 10, wherein
the element current passes through at least one of a first path, a second path, or a third path,
the first path includes the first magnetic pole, the element portion, and the second magnetic pole,
the second path includes the third magnetic pole, the element portion, and the second magnetic pole, and
the third path includes the fourth magnetic pole, the element portion, and the second magnetic pole.

12. The magnetic recording device according to claim 10, wherein
a time average of the element current is greater than a time average of the magnetic pole current.

13. The magnetic recording device according to claim 5, wherein
the element portion includes a first-pole-side non-magnetic layer in contact with the first pole, and
the first-pole-side non-magnetic layer includes at least one selected from the group consisting of Ru, Ta, Ir, Rh, Pd, Pt, and W.

14. The magnetic recording device according to claim 13, wherein
the element portion further includes a first stacked body,
the first pole side non-magnetic layer is between the first pole and the first stacked body,
the first stacked body includes a first magnetic layer and a first non-magnetic layer, and
the first magnetic layer is between the first pole side non-magnetic layer and the first non-magnetic layer.

15. The magnetic recording device according to claim 1, wherein
the magnetic head further includes
a first non-magnetic conductive layer between the third magnetic pole and the first magnetic pole, and
a second non-magnetic conductive layer between the first magnetic pole and the fourth magnetic pole.

16. The magnetic recording device according to claim 1, wherein
the magnetic head further includes a fifth magnetic pole and a third non-magnetic conductive layer,
the first magnetic pole is between the fifth magnetic pole and the second magnetic pole, and
the third non-magnetic conductive layer is between the fifth magnetic pole and the first magnetic pole.

17. The magnetic recording device according to claim 1, wherein
the coil current circuit is configured to change the polarity of the coil current according to a recording information.
